(19) United States
(12) Patent Application Publication
(10) Pub. No.: US 2009/0095608 A1
(43) Pub. Date: Apr. 16, 2009

(54) SWITCHING MECHANISM FOR SWALLOWABLE MEDICAL DEVICE

(75) Inventor: Kentaro MATSUMOTO, Saitama (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/247,356

(22) Filed: Oct. 8, 2008

(30) Foreign Application Priority Data
Oct. 12, 2007 (JP) 2007-266276

(51) Int. Cl. H01H 3/20

(52) U.S. Cl. 200/323

(57) ABSTRACT

A switching mechanism has first and second contacts, an elastic member, and a stopper. The first and second contacts are electrically connectable with each other. The operation of the first circuit is switched by electrically connecting the first and second contacts. The stopper maintains the elastic member in an elastically deformed state. At least a part of the stopper is capable of disintegrating by contact with a predetermined liquid. The elastic member recovers from deformation as at least of a part of the stopper disintegrates, and thereby displaces the second contact such that the second contact gets electrically connected to or disconnected from the first contact.

### BACKGROUND OF THE INVENTION

1. Field of the Invention

The present invention relates to a switching mechanism for a swallowable medical device such as a capsule endoscope, and in particular, for switching an operation of the medical device when initiating use.

2. Description of the Related Art

A capsule endoscope is well known as an endoscope for observing the insides of a human body such as the stomach or intestines. Circuits in the capsule endoscope are driven by a power-supply unit such as a battery which is provided in the capsule endoscope, but they can be driven only for a short period by the battery because of the limited available charge. Therefore, the capsule endoscope is usually turned on by the doctor just before being swallowed by the patient, in order to reduce unnecessary power consumption. Furthermore, it is preferable that the endoscope be turned on by a simple operation and without disassembling, in order to ensure a seal of the interior.

Conventionally, a switching mechanism utilizing a magnet is known as a means for turning on the power supply of the capsule endoscope, as shown in international Publication NO. WO/2001/035813. In this mechanism, the capsule endoscope is stored in a case with a magnet, and when the capsule endoscope is removed from the case the capsule endoscope is turned on automatically by the change in magnetic field. This mechanism does not require the disassembly of the capsule endoscope and can provide an easy power-on operation.

However, in this mechanism, all the cases must have a magnet, and a number of magnets corresponding to cases or endoscopes are necessary. In addition, the case and the endoscope are usually single-use. Accordingly, a large number of magnets are required. Furthermore, in this mechanism, the power supply can be started by removing the capsule endoscope from the case. However, after swallowing, the long time it takes for the endoscope to reach the region to be observed by a doctor (such as the intestines or the stomach), wastes valuable electrical power. This requires a larger battery, increasing the size and manufacturing cost of the capsule endoscope.

In addition, when the capsule endoscope is powered on, it emits radio waves in order to transmit data such as image data. While the endoscope is still outside the body, the unmitigated radio waves may adversely affect peripheral devices.

### SUMMARY OF THE INVENTION

Therefore, an object of the present invention is to provide a simple switching mechanism for a swallowable medical device, which can alter the operation of a circuit after the device is swallowed, without the use of a magnet.

According to the present invention, there is provided a switching mechanism for a swallowable medical device having a shell and a first circuit unit provided in the interior of the shell. The switching mechanism comprises first and second contacts, an elastic member, and a stopper. The first and second contacts are electrically connectable with each other and provided in the interior of the shell, and the first circuit unit is operated by electrically connecting the first and second contacts. The stopper maintains the elastic member in an elastically deformed state. At least a part of the stopper is capable of disintegrating by contact with predetermined liquid. The elastic member recovers from deformation as at least a part of the stopper disintegrates, and thereby displaces the second contact such that the second contact gets electrically connected to or disconnected from the first contact.

### BRIEF DESCRIPTION OF THE DRAWINGS

The objects and advantages of the present invention will be better understood from the following description, with reference to the accompanying drawings in which:

FIG. 1 is a schematic view, partly sectioned, of a capsule endoscope in the first embodiment of the present invention;

FIG. 2 is a schematic view, partly sectioned, of a capsule endoscope in the second embodiment of the present invention;

FIG. 3 is a schematic view, partly sectioned, of a capsule endoscope in the third embodiment of the present invention; and

FIG. 4 is a schematic view, partly sectioned, of a capsule endoscope in the fourth embodiment of the present invention.

### DESCRIPTION OF THE PREFERRED EMBODIMENTS

The present invention will be described below with reference to the embodiments shown in the drawings.

A switching mechanism for the capsule endoscope is explained below, but the switching mechanism in these embodiments can be applied to any other swallowable medical devices.

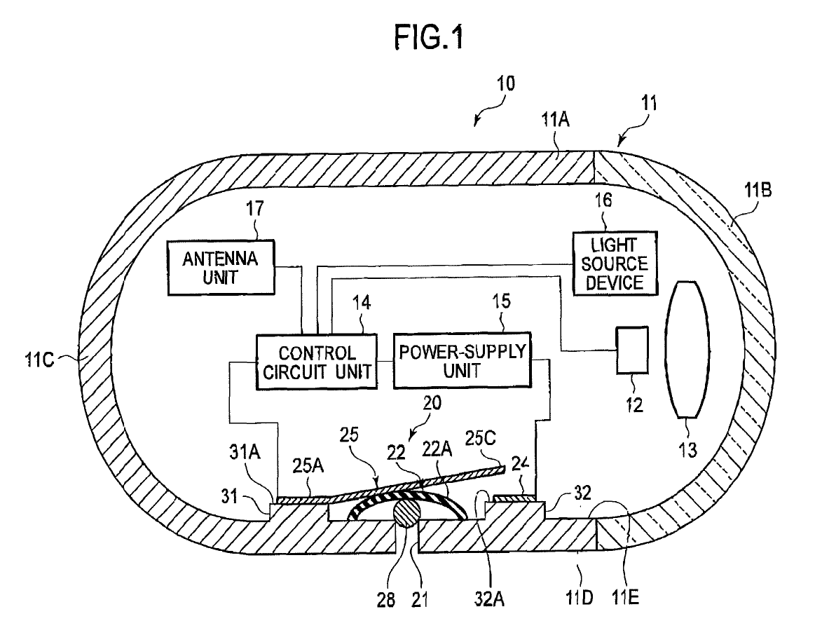

FIG. 1 shows a capsule endoscope in the initial state before the power supply is turned on in the first embodiment. The capsule endoscope 10 is a swallowable medical device for observing the inside of a human body and enters the human body by being swallowed. The capsule endoscope 10 has a shell 11 which seals its interior. The shell 11 has a body 11A which is opaque and cylindrical, a transparent cover 11B which covers one end of the body 11A, and an opaque cover 11C which covers the other end thereof. The covers 11B and 11C are dome-shaped. In FIG. 1, the main axis of the body 11A extends in the horizontal direction.

The capsule endoscope 10 has an imaging device 12, a lens system 13, a control circuit unit (a first circuit unit) 14, a power-supply unit (a second circuit unit) 15 such as a battery, a light source device 16, and an antenna unit 17, all inside the space of the shell 11. The power-supply unit 15 supplies the electrical power to the control circuit unit 14. The control circuit unit 14 operates with the supplied electrical power. The control circuit unit 14 has several circuits including a driving circuit for driving the devices 12 and 16 and the antenna unit 17.

The lens system 13 forms an image of the object illuminated by the light source device 16 on the imaging device 12. The imaging device 12 captures the object image and generates the image data from the object image. The image data is transmitted to the outside of the capsule endoscope 10 by the antenna unit 17 through radio waves. The radio waves are received by a data-receiving apparatus which is located outside of the capsule endoscope 10.

The capsule endoscope 10 has a switching mechanism 20. The switching mechanism 20 has an immovable contact 24 (a first contact), a leaf spring 25 an which a second contact is provided, an elastic cover member (first cover member) 22, and a stopper 28. In this embodiment, the switching mechanism 20 is used for turning on the power supply of the control circuit unit 14 (namely, the endoscope 10) by connecting the first and second contacts. The switching mechanism may also be used for altering any kind of operation of the control circuit unit 14.

The shell 11 has a hole 21 which penetrates the body 11A. The elastic cover member 22 which is a membrane covers the hole 21 on the inner side of the shell 11. An edge of the elastic cover member 22 is bonded to the inner surface 11E around the hole 21 such that the hole 21 is sealed by the elastic cover member 22. Due to this seal, the elastic cover member 22 prevents liquid from leaking into the endoscope 10. Namely, the shell 11 is watertight. A center portion of the elastic cover member 22 is not bonded to the inner surface 11E. The center portion is stretchable and deformable by pressure.

The elastic cover member 22 is formed of an elastic material such as rubber or resin and the like. Any kind of rubber or resin may be used as the elastic material. For example, the elastic cover member 22 may be formed of a biocompatible rubber. The elastic cover member 22 is preferably formed of an insulating material so as to isolate itself from the leaf spring 25.

The immovable contact 24 and the leaf spring 25 which are formed of metal are provided in the shell 11. The body 11A has first and second bumps 31 and 32 which protrude inward from the inner surface 11E. The first and second bumps 31 and 32 are arranged along the axial direction of the shell 11 so as to interpose the elastic cover member 22 between them. The immovable contact 24 is fixed on a top surface 32A of the second bump 32. The immovable contact 24 is bonded to the top surface 32A by au adhesive, or is formed by depositing a metallic material onto the top surface 32A.

The leaf spring 25 is arranged on the inner side of the elastic cover member 22. The leaf spring 25 is oriented along the axial direction of the shell 11. A base end 25A of the leaf spring 25 is fixed on a top surface 31A of the first bump 31 by an adhesive or the like. The leaf spring 25 extends from the first bump 31 toward the second bump 32 while contacting inner surface 22A of the elastic cover member 22. A tip end 25C (a second contact) of the leaf spring 25 is arranged above the immovable contact 24. Namely, the tip end 25C is located on the inner side of the immovable contact 24.

The tip end 25C contacts the immovable contact 24 when the leaf spring 25 is not pressed by the elastic cover member 22, i.e., when the leaf spring 25 is not deflected and has recovered from deformation. On the other hand, in the initial state in FIG. 1, namely, before the endoscope 10 is swallowed, the leaf spring 25 is pressed by the elastic cover member 22 inward such that the leaf spring 25 is deflected and is maintained in an elastically deformed state, as described below. Due to this deformation of the leaf spring 25, the tip end 25C is separated from the immovable contact 24.

The power-supply unit 15 and the control circuit unit 14 electrically connect the immovable contact 24 and the leaf spring 25, respectively, via an electric lead and the like. When the tip end 25C contacts with the immovable contact 24, the electrical power is supplied from the power-supply unit 15 to the control circuit unit 14. The control circuit unit 14 to which the electrical power is supplied operates so as to drive the light source device 16, the imaging device 12, and the antenna unit 17 as described above.

While the tip end 25C electrically disconnects from the immovable contact 24 by separating from the contact 24, electrical power is no longer supplied to the control circuit unit 14. In that case, the operation of the control circuit unit 14 is not performed and the light source device 16, the imaging device 12, and the antenna unit 17 are not driven.

In the initial state in FIG. 1, the stopper 28 is provided in space defined by the elastic cover member 22 and the inner surface 11E. The stopper 28 is a lump formed of a material which can be dissolved by predetermined liquid (aqueous liquid). The lump may be substantially spheroidal. The predetermined liquid is a bodily fluid such as a digestive fluid. Examples of digestive fluids include saliva, gastric fluid, intestinal fluid, and bile. Salt (sodium chloride) is the preferred material to be dissolved by the predetermined liquid.

In the initial state, the stopper 28 is located over the hole 21 and the elastic cover member 22 is pressed inward by the stopper 28. The elastic cover member 22 is expanded inward and is maintained in the elastically deformed state by the pressure from the stopper 28. Also, the leaf spring 25 is pressed inward by the stopper 28 by force exerted through the elastic cover member 22 and is in an elastically deformed state, such that the tip end 25C is separated from the immovable contact 24.

When the capsule endoscope 10 is swallowed and enters the human body, digestive fluid (for example, saliva), which passes the hole 21, contacts and dissolve the stopper 28. Due to the dissolution of the stopper 28, the elastic cover member 22 and the leaf spring 25 are not pressed by the stopper 28. Accordingly, the leaf spring 25 recovers from deformation together with the elastic cover member 22 due to their resilience, and thereby the tip end 25C is displaced outward and forms contact with the immovable contact 24. When the tip end 25C forms contact with the immovable contact 24, the operation of the control circuit unit 14 starts by supplying the electrical power from the power-supply unit 15 to the control circuit unit 14.

The size of the lump may be determined so that the power supply starts when the endoscope 10 reaches an target region (for example, the stomach or intestines) which should be observed by the user or reaches a place close to the target region, taking into consideration the rate of the dissolution of the stopper 28 by the bodily fluid. Namely, the delay in the switching of the endoscope, and thereby the location along gastrointestinal tract can be adjusted by changing the size of the stopper 28.

As described above, in this embodiment, before swallowing the capsule endoscope 10, the devices 12 and 16 and the antenna unit 17 are not driven. This can reduce the power consumption prior to swallowing. Also, the antenna unit 17 starts transmitting radio waves after the endoscope 10 enters the human body. This delay prevents the radio waves from adversely affecting peripheral devices located outside of the endoscope 10, because the radio waves are partially shielded by the human body.

Furthermore, in this embodiment, the switching mechanism 20 does not require any specific operations of the user for turning the power supply on, because the operation of the control circuit unit 14 starts automatically through contact with the bodily fluid. In addition, because the power-supply unit 15 is electrically separated from the control circuit unit 14 in the initial state, the electrical power consumption in the power-supply unit 15 is more effectively reduced.

In this embodiment, the shell 11 may have a plurality of fine holes on condition that the elastic cover member 22 covers the plurality of fine holes. In such a case, the amount of liquid which passes through the holes can be adjusted by changing the number of the holes. Therefore, the period from the swallow to the activation can be determined according to the user's wishes. The period from the swallow to the activation can also be determined by changing the diameter of the hole(s).

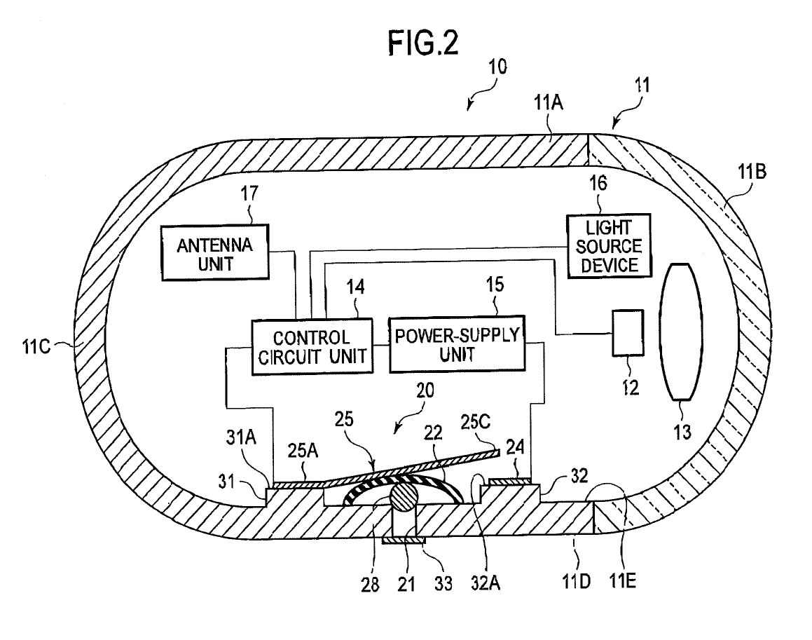

FIG. 2 shows the endoscope 10 of the second embodiment. The difference between this embodiment and the first embodiment is that the switching mechanism has a second cover member 33 which is a membrane. The difference is explained below.

As shown in FIG. 2, the second cover member 33 covers the side of the hole 21 opposite the elastic cover member 22. The periphery of the second cover member 33 is bonded to the outer surface 11D of the shell 11 around the hole 21 so as to seal the hole 21. The second cover member 33 which is a membrane is dissolvable by a specific liquid (an aqueous liquid). The specific liquid is a bodily fluid, for example, and the example of the bodily fluid is the same as that described above.

For example, the second cover member 33 is formed of a material dissolvable by a solution with a pH less than a predetermined value but not by a solution with a pH more than or equal to the predetermined value. Specifically, the second cover member 33 is dissolved by an acidic solution but not by an alkaline or neutral solution. Therefore, even when the capsule endoscope 10 is exposed to alkaline or neutral liquid, the liquid does not pass the hole 21 due to the obstruction of the second cover member 33 which has not dissolved, and the stopper 28 is prevented from contacting the liquid and dissolving.

Namely, the second cover member 33 is not dissolved by some liquid (for example, saliva) which can dissolve the stopper 28. Accordingly, in this embodiment, when the capsule endoscope 10 is placed in the mouth and is exposed to saliva, the second cover member 33 is not dissolved by saliva, thereby protecting stopper 28 from dissolution. On the other hand, when the capsule endoscope 10 reaches the stomach, the second cover member 33 is dissolved by gastric fluid which is acidic. After the second cover member 33 dissolves, the gastric fluid which passes the hole 21 contacts and dissolves the stopper 28. With the stopper 28 dissolving, the operation of the control circuit unit 14 starts, similarly to the first embodiment.

Furthermore, the second cover member 33 may be formed of a material dissolvable by a solution with a pH more than a predetermined value but not dissolvable by a solution with a pH less than or equal to the predetermined value. In such a case, the second cover member 33 is not dissolved by saliva or acidic gastric fluid, but is dissolved in the intestines by intestinal fluid or bile which is alkaline. Accordingly, in this case, when the capsule endoscope 10 reaches the intestines, the stopper 28 is dissolved and the operation of the control circuit unit 14 starts.

Namely, it is preferable that the second cover member 33 be dissolvable by liquid with a pH within a predetermined range but not by liquid with a pH beyond the predetermined range. In addition, the second cover member 33 may be bonded to the inner surface 11E of the shell 11 or an inner surface of the hole 21 instead of the outer surface 11D.

In this embodiment, the operation of the control circuit unit 14 starts when the endoscope 10 reaches the desired organ such as stomach or intestines. Therefore, the electrical power consumption of the power-supply unit 15 can more effectively be reduced.

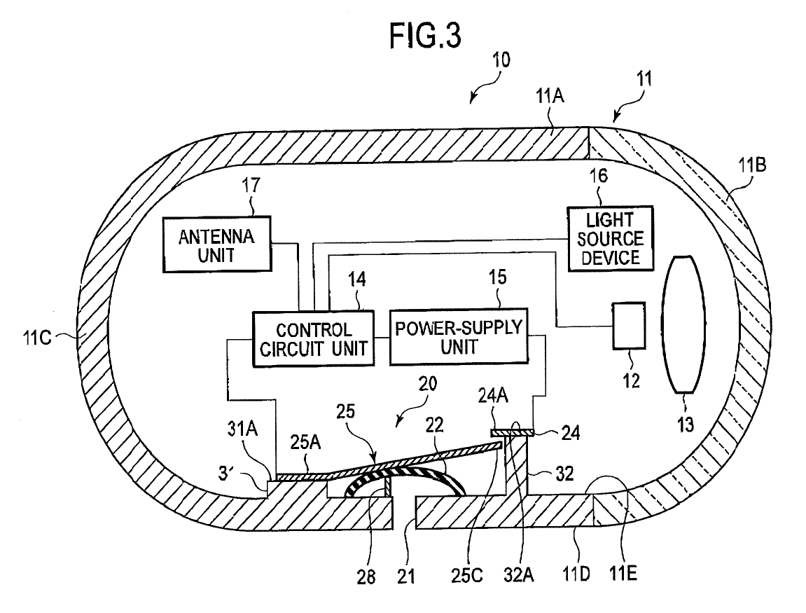

FIG. 3 shows the endoscope 10 in the third embodiment. In the first and second embodiments, the elastic cover member 22 and the leaf spring 25 are pressed by the stopper 28 so as to maintain them in the elastically deformed state. However, in the third embodiment, the elastic cover member 22 and the leaf spring 25 are pulled by the stopper 28 so as to maintain them in an elastically deformed state. The difference between the third embodiment and the first and second embodiments is explained below.

In this embodiment, the second bump 32 protrudes higher than the first bump 31, such that the top surface 32A of the second bump 32 is located more inwardly than the top surface 31A of the first bump 31. The immovable contact 24 is fixed on the top surface 31A and a part (a protruding portion 24A) of the immovable contact 24 protrudes from the top surface 32A toward the first bump 31. The tip end 25C of the leaf spring 25 is arranged below the protruding portion 24A. Namely, the tip end 25C is located on the outer side of the protruding portion 24A.

In this embodiment, the contacting portion of the leaf spring 25 with the elastic cover member 22 is bonded to the elastic cover member 22. Therefore, the leaf spring 25 moves inward or outward following the inward or outward deformation of the elastic cover member 22. The tip end 25C contacts the protruding portion 24A when the leaf spring 25 is not pulled outward, namely when the leaf spring 25 is not deflected and recovers from elastic deformation.

The stopper 28 in this embodiment is formed into a thread which couples the elastic cover member 22 with the inner surface 11E of the shell 11. In the initial state in FIG. 3, the stopper 28 is in tension, and the leaf spring 25 and the elastic cover member 22 are pulled outward together by the stopper 28. Accordingly, the leaf spring 25 is deflected outward and is maintained in the elastically deformed state by the stopper 28, such that the tip end 25C is separated from the protruding portion 24A. The thread of the stopper 28 may be formed of twisted paper, for example. A part of the stopper 28 is dissolvable by the predetermined liquid above, and therefore, the stopper 28 is weakenable and breakable by contact with the predetermined liquid.

When the capsule endoscope 10 is swallowed, the stopper 28 is eroded by fluid (e.g. saliva) and loses strength in the mouth, for example. Then, the weakened stopper 28 is broken by the force of the leaf spring 25. Due to this, the leaf spring 25 recovers from deformation together with the elastic cover member 22, and thereby displaces the tip end 25C inward, so that the tip end 25C contacts the protruding portion 24A of the immovable contact 24. Accordingly, in this embodiment, the operation of the control circuit unit 14 can start after swallowing, similarly to the first embodiment.

In the first to third embodiments, the stopper 28 is dissolved or weakened by the predetermined liquid so as to restore the leaf spring 25 from deformation. However, the stopper is not limited to the above structures if at least a part of the stopper 28 is capable of disintegrating by contact with the predetermined liquid and the leaf spring 25 recovers from deformation as at least a part of the stopper 28 disintegrates.

For example, the stopper 28 maybe formed into the lump, similarly to that in the first embodiment, and a whole or a part of the stopper 28 may be decomposable by the predetermined liquid, instead of dissolvable by the predetermined liquid. In such a case, a whole or a part of the stopper 28 is decomposed by contact With the predetermined liquid; and then the leaf spring 25 recovers from deformation, similarly to that in the first embodiment.

Also, a whole or a part of the second cover member 33 may be decomposable by the specific liquid instead of dissolvable by the specific liquid. Namely, the second cover member 33 is not limited to the above-mentioned structure, if the second cover member 33 is capable of disintegrating by contact with the specific liquid and can allow the liquid to pass through the hole 21 after disintegrating.

Furthermore, in the above embodiment the stopper 28 may be capable of disintegrating (e.g. by dissolving or weakening) by contact with liquid with a pH within a predetermined range but not by contact with liquid with a pH beyond the predetermined range.

For example, the stopper 28 may be capable of disintegrating by contact with a liquid with a pH less than a predetermined value but not by contact with a liquid with a pH more than or equal to the predetermined value. Namely, the stopper 28 may he capable of disintegrating by contact with an acidic liquid but not by contact with a neutral or alkaline liquid, for example.

Similarly, the stopper 28 may be capable of disintegrating by contact with a liquid with a pH more than a predetermined value but may not by contact with a liquid with a pH less than or equal to the predetermined value.

In the above-mentioned third embodiment, a thread which is weakenable and breakable by a solution with a pH less than a predetermined value but not by a solution with a pH more than or equal to the predetermined value may alternatively be used as the stopper 28. In this case, the stopper 2B is not substantially disintegrated by saliva, but instead by gastric fluid. Accordingly, the operation of the control circuit unit 14 does not start just after swallowing, but rather when the endoscope 10 reaches the stomach.

Furthermore, a thread which is weakenable and breakable by a solution with a pH more than a predetermined value but not by a solution with a pH less than or equal to the predetermined value may be used as the stopper 28. In this case, the operation of the control circuit unit 14 starts when the endoscope 10 reaches the intestines and the stopper 28 is broken by the intestinal fluid or bile.

Similarly, in the first and second embodiments, a lump formed of a material dissolvable by a solution with a pH less than a predetermined, value but not by a solution with a pH more than or equal to the predetermined value may be used as the stopper 28. Also, a lump formed of a material dissolvable by a solution with a pH more than a predetermined value but not by a solution with a pH less than or equal to the predetermined value may be used as the stopper 28.

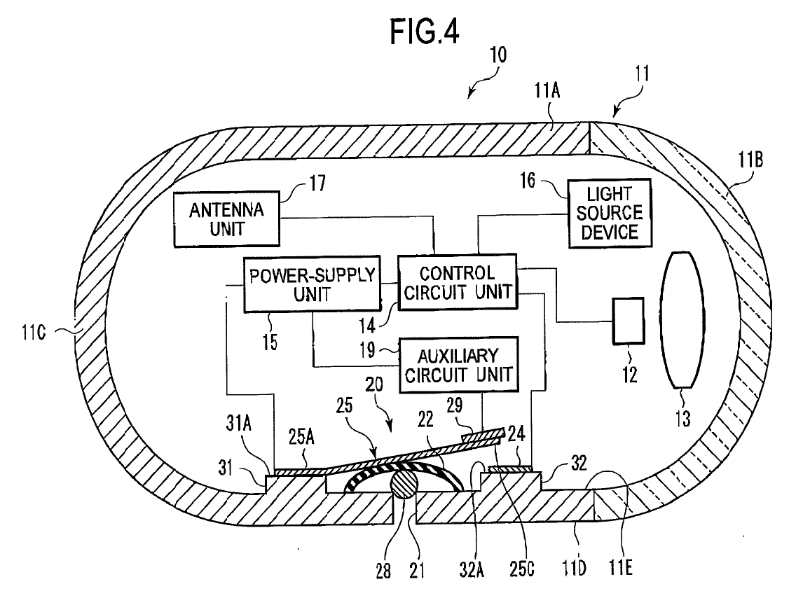

FIG. 4 shows the capsule endoscope 10 in the fourth embodiment. In this embodiment, the capsule endoscope 10 also has an auxiliary circuit unit 19 and an auxiliary immovable contact 29 in the shell 11.

The auxiliary circuit unit 19 may be a timer, for example. The auxiliary circuit unit 19 measures time using the electrical power from the power-supply unit 15. The power-supply unit 15, the control circuit unit 14, and the auxiliary circuit unit 19 electrically connect with the leaf spring 25, the immovable contact 24, and the auxiliary immovable contact 29, respectively, through electric leads, for example.

In the initial state, the leaf spring 25 is pressed and is elastically deformed inward by stopper 28, similarly to the first embodiment, and the tip end 25C contacts the auxiliary immovable contact 29. Therefore, in the initial state, the auxiliary circuit unit 19 electrically connects the power-supply circuit unit 15, and the auxiliary circuit unit 19 operates with the supplied electrical power. Namely, in this embodiment, before operation or the control circuit unit 14, the waiting time is measured by the auxiliary circuit unit 19.

The leaf spring 25 recovers from deformation by dissolving the stopper 28 and thereby the tip end 25C displaces outward. The displaced end 25C is separated from the auxiliary immovable contact 29 and makes contact with the immovable contact 24. Due to this, the control circuit unit 14 electrically connects to the power-supply unit 15 and operates with the power supply from the power-supply unit 15. Furthermore, the tip end 25C gets disconnected from the auxiliary immovable contact 29. Hence, the electrical power supplied to the auxiliary circuit unit 19 stops and the timing by the auxiliary circuit unit 19 stops.

As described above, in this embodiment, the circuit unit which receives power may be switched from the auxiliary circuit unit 19 to the control circuit unit 14 by the disintegration of the stopper 28.

Although the embodiments of the present invention have been described herein with reference to the accompanying drawings, obviously many modifications and changes can be made by those skilled in this art without departing from the scope of the invention.

The present disclosure relates to subject matter contained in Japanese Patent Application No. 2007-266276 (filed on Oct. 12, 2007) which is expressly incorporated, herein, by reference, in its entirety.

1. A switching mechanism for a swallowable medical device, said device comprising a shell and a first circuit unit provided in the interior of said shell, said switching mechanism comprising:
first and second contacts that are electrically connectable with each other and provided in said interior, said first circuit unit being operated when said first and second contacts are electrically connected;
an elastic member; and
a stopper that maintains said elastic member in an elastically deformed state, at least a part of said stopper capable of disintegrating by contact with a predetermined liquid,
said elastic member recovering from deformation as at least a part of said stopper disintegrates, thereby displacing said second contact such that said second contact gets electrically connected to or disconnected from said first contact.

2. The switching mechanism as claimed in claim 1, wherein said stopper presses or pulls said elastic member to maintain an elastically deformed state.

3. The switching mechanism as claimed in claim 1, wherein said shell comprises a hole that is covered by a first cover member, said stopper provided on the outer side of said first cover member.

4. The switching mechanism as claimed in claim 3, wherein said elastic member is provided on the inner side of said first cover member, said elastic member being pressed or pulled by said stopper by force exerted through said first cover member so as to elastically deform said elastic member.

5. The switching mechanism as claimed in claim 3, wherein said first cover member covers said hole on an inner side of said shell, said stopper disposed in an area between said first cover member and said shell.

6. The switching mechanism as claimed in claim 3, wherein said switching mechanism comprises a second cover member capable of disintegrating by contact with a specific liquid, said second cover member covering said hole from the side of said stopper opposite the first cover member.

7. The switching mechanism as claimed in claim 3, wherein said switching mechanism comprises a second cover member capable of disintegrating by contact with a specific liquid, said stopper being disintegrated by said predetermined liquid after said second cover member disintegrates.

8. The switching mechanism as claimed in claim 6, wherein said second cover member is capable of disintegrating by contact with liquid with a pH within a predetermined range but not by contact with liquid with a pH beyond said predetermined range.

9. The switching mechanism as claimed in claim 1, wherein said shell comprises a hole and said elastic member comprises an elastic cover member that covers said hole, said stopper provided on the outer side of said elastic cover member.

10. The switching mechanism as claimed in claim 9, wherein said elastic member further comprises a spring member that is located on the inner side of said elastic cover member, said spring member maintained in an elastically deformed state by said elastic cover member.

11. The switching mechanism as claimed in claim 10, wherein said spring member recovers from deformation together with said elastic cover member by said stopper disintegrating, and thereby displaces said second contact.

12. The switching mechanism as claimed in claim 1, wherein said second contact is provided on said elastic member.

13. The switching mechanism as claimed in claim 12, wherein said elastic member includes a leaf spring, said second contact provided on an end of said leaf spring.

14. The switching mechanism as claimed in claim 1, wherein said stopper is dissolvable, decomposable or weakenable by said predetermined liquid.

15. The switching mechanism as claimed in claim 1, wherein said stopper is formed into a lump or a thread.

16. The switching mechanism as claimed in claim 1, wherein said predetermined liquid is a bodily fluid.

17. The switching mechanism as claimed in claim 1, wherein said stopper is capable of disintegrating by contact with liquid with a pH within a predetermined range but not by contact with liquid with a pH beyond said predetermined range.

18. The switching mechanism as claimed in claim 1, wherein said device further comprises a second circuit unit electrically connectable to said first circuit unit, said first and second circuits unit electrically connecting with said first and second contacts, respectively,
the connection between said first and second circuit units being switched by electrically connecting or disconnecting said first contact to or from said first contact.

19. The switching mechanism as claimed in claim 18, wherein one of said first and second circuit units is a power-supply unit, and the other of said first and second circuit units is an operation circuit unit that is operated by electrical power supplied by said power-supply unit.
